(19) United States
(12) Patent Application Publication
(10) Pub. No.: US 2026/0196756 A1
(43) Pub. Date: Jul. 9, 2026

(54) ELECTRICAL CONNECTOR

(71) Applicant: Fujikura Ltd., Tokyo (JP)

(72) Inventors: Toshihiko Hirai, Tokyo (JP); Sho Ohtsuka, Tokyo (JP); Masato Hida, Tokyo (JP)

(73) Assignee: Fujikura Ltd., Tokyo (JP)

(21) Appl. No.: 19/128,458

(22) PCT Filed: Jan. 10, 2024
(86) PCT No.: PCT/JP2024/000304

§ 371 Date: May 8, 2025

(30) Foreign Application Priority Data
Jan. 13, 2023 (JP) 2023-004032

(51) Int. Cl. H01R 12/77; H01R 12/79

(52) U.S. Cl. CPC H01R 12/774; H01R 12/79

(57) ABSTRACT

An electrical connector includes: a terminal to which a signal transmission member is electrically connected; a housing that holds the terminal and that includes an insertion part into which the signal transmission member is inserted; a lock that is rotatably supported by the housing and that includes a hook that engages with the signal transmission member; a cover that includes a plate that covers the housing; and a first protruding piece that biases the lock toward a lock position in which the hook engages with the signal transmission member and that includes a contact part in contact with the lock. The cover is held by the housing such that the lock is interposed between the housing and the cover. The first protruding piece is disposed on an opposite side of the signal transmission member with respect to the lock and that protrudes from the plate toward the lock.

### TECHNICAL FIELD

The present invention relates to an electrical connector.

For designated countries that are permitted to be incorporated by reference in the literature, the contents of Japanese Patent Application No. 2023-004032 filed with Japan Patent Office on Jan. 13, 2023 is incorporated herein by reference and is regarded as a part of the description of this specification.

### BACKGROUND

A connector is known that includes an insulator having an insertion part into which a cable can be inserted and removed, an actuator that is rotatably supported by the insulator and that locks the cable, and a biasing member that biases the actuator toward a lock position (refer to, for example, Patent Document 1). In this connector, the cable is locked to the connector by engaging a projection of the actuator pressed downward by the biasing member with the cable.

### PATENT LITERATURE

PATENT DOCUMENT 1: JP 2021-34220 A

In the above-mentioned connector, the abutting part of the biasing member is located above the actuator, while the lock part of the biasing member is located below the actuator. An elastic part is interposed between the abutting part and the lock part. For this reason, the biasing member must be installed at the outside of the insertion part in the housing, and the abutting surface of the actuator against which the abutting part of the biasing member abuts is separated from the projection of the actuator. Therefore, the actuator may bend due to the pressing by the biasing member, and the holding force for holding the cable may not be sufficiently secured.

### SUMMARY

One or more embodiments of the present invention provide an electrical connector capable of improving the holding force for holding a signal transmission member.
[1] An aspect 1 of the present invention is an electrical connector comprising: a terminal to which a signal transmission member is electrically connected; a housing that holds the terminal and that comprises an insertion part into which the signal transmission member is inserted; a lock member that is rotatably supported by the housing and that comprises a hook that engages with the signal transmission member; a cover member that comprises a plate-shaped part that covers the housing; and a biasing member that biases the lock member toward a lock position in which the hook engages with the signal transmission member and that comprises a contact part in contact with the lock member, wherein the cover member is held by the housing so that the lock member is interposed between the housing and the cover member, the biasing member is a first protruding piece that is located on an opposite side of the signal transmission member with respect to the lock member and that protrudes from the plate-shaped part toward the lock member, the lock member is rotatable between the lock position and an unlock position in which the signal transmission member can be removed from the insertion part; and the hook and the contact part are located on a same virtual plane extending in a direction substantially perpendicular to a rotation axis of the lock member.
[2] An aspect 2 of the present invention may be the electrical connector of the aspect 1, wherein the biasing member may be integrally formed with the plate-shaped part.
[3] An aspect 3 of the present invention may be the electrical connector of the aspect 1 or 2, wherein the cover member may be a shell made of a conductive material, and the shell may comprise a second protruding piece that is integrally formed with the plate-like part and that is electrically connected to the signal transmission member.
[4] An aspect 4 of the present invention may be the electrical connector of any one of the aspects 1 to 3, wherein the lock member may comprise a pair of lock arms each of which comprises the hook at a front-end, and the contact part may be in contact with the lock arm.
[5] An aspect 5 of the present invention may be the electrical connector of any one of the aspects 1 to 4, wherein the lock member may comprise: a pair of lock arms each of which comprises the hook at a front-end; a connection part that connects the pair of arms; and an operation part that is disposed on the connection part; and the cover member may have a cutout or an opening through which the operation part is exposed.
[6] An aspect 6 of the present invention may be the electrical connector of the aspect 5, wherein the cover member may comprise a third protruding piece that is integrally formed with the plate-like part and that is in contact with the connection part to bias the lock member toward the lock position.
[7] An aspect 7 of the present invention may be the electrical connector of any one of the aspects 1 to 6, wherein the biasing member may comprise: the contact part that is a free end; a fixed end; and an extension part that extends between the contact part and the fixed end, and the contact part, the extension part, and the fixed end may be located on an opposite side of the signal transmission member with respect to the lock member.

In the present invention, the hook of the lock member and the contact part of the biasing member are located on the same virtual plane extending in a direction substantially perpendicular to the rotation axis of the lock member. Accordingly, in the present invention, it is possible to locate the portion of the lock member in which the contact part is in contact close to the hook, and therefore it is possible to improve the holding force of the electrical connector for holding the signal transmission member.

### BRIEF DESCRIPTION OF THE DRAWINGS

FIG. 1 is a perspective view of the connector, the wiring board, and the flexible printed wiring board as viewed from above in one or more embodiments of the present invention;

FIG. 2 is an exploded perspective view showing the connector in one or more embodiments of the present invention;

FIG. 3 is a view of the housing in one or more embodiments of the present invention and is an enlarged plan view of part III in FIG. 2;

FIG. 4 is an end view taken along line IV-IV in FIG. 1;

FIG. 5 is a perspective view of the lock member as viewed from below in one or more embodiments of the present invention;

FIG. 6 is a cross-sectional view taken along line VI-VI in FIG. 1;

FIG. 7 is a perspective view of the shell as viewed from below in one or more embodiments of the present invention;

FIG. 8 is a cross-sectional view taken along line VIII-VIII in FIG. 1;

FIG. 9 is a plan view of the connector in one or more embodiments of the present invention; and

FIG. 10(a) to FIG. 10(c) are cross-sectional views showing the operation of the connector in one or more embodiments of the present invention, FIG. 10(a) shows a state in the middle of inserting a flexible printed wiring board into the connector, FIG. 10(b) shows a state in which the lock member locks the flexible printed wiring board, and FIG. 10(c) shows a state in which the lock of the lock member 30 is released and the flexible printed wiring board 60 is removed from the connector 1.

### DETAILED DESCRIPTION

Hereinafter, one or more embodiments of the invention will be described with reference to the drawings.

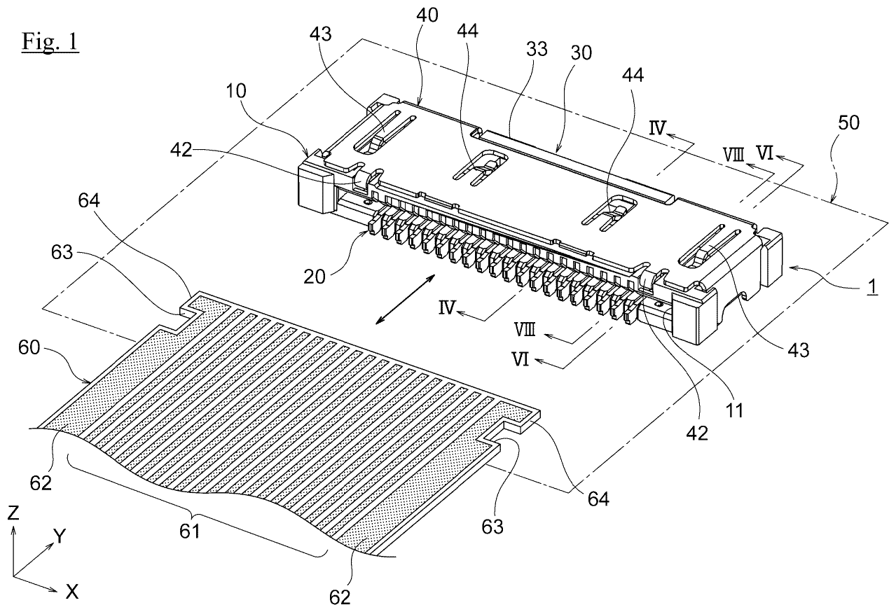

FIG. 1 is a perspective view of the connector 1, the wiring board 50, and the flexible printed wiring board (FPC) 60 as viewed from above in one or more embodiments of the present invention.

As shown in FIG. 1, the connector 1 in one or more embodiments is an electrical connector mounted on the wiring board 50. The connector 1 electrically connects the wiring board 50 and the flexible printed wiring board 60 inserted into the insertion part 11 (described below) of the housing 10. Although the wiring board 50 in one or more embodiments is a rigid board, the wiring board 50 is not limited to thereto, and a board other than a rigid board may be used as the wiring board 50.

The flexible printed wiring board 60 includes a plurality of (20 in one or more embodiments) signal patterns 61 and a pair of ground patterns 62. When the flexible printed wiring board 60 is inserted into the connector 1, the terminal 20 (described later) of the connector 1 contacts each of the signal patterns 61, while the protruding piece 42 (described later) of the shell 40 of the connector 1 contacts each of the ground patterns 62.

The flexible printed wiring board 60 also includes a pair of cutouts 63 in the vicinity of the front-end thereof. The pair of cutouts 63 are formed on both ends of the flexible printed wiring board 60 in the lateral direction (X direction in the figure). The portion of the flexible printed wiring board 60 on the front-end side (+Y direction in the figure) of the cutout 63 forms a convex part 64 that protrude in the lateral direction (X direction in the figure). When the flexible printed wiring board 60 is inserted into the connector 1, the hooks 311 (described below) of the lock member 30 of the connector 1 enter the cutouts 63, and the hooks 311 and the convex parts 64 engage with each other.

The number and shape of the wiring patterns of the flexible printed wiring board 60 including the signal pattern 61 and the ground pattern 62 are not particularly limited to those described above, and it can be set arbitrarily. Furthermore, although the flexible printed wiring board 60 of one or more embodiments includes the wiring patterns on only one side thereof, the flexible printed wiring board inserted into the insertion part 11 of the connector 1 may have the wiring patterns on both sides thereof.

The flexible printed wiring board 60 corresponds to an example of the “signal transmission member” in the aspect of the present invention. The signal transmission member inserted into the insertion part 11 of the connector 1 is not limited to the flexible printed wiring board 60 described above, and may be, for example, a flexible flat cable (FFC).

In one or more embodiments, the insertion/removal direction (Y direction in the figure) in which the flexible printed wiring board 60 is inserted into and removed from the connector 1 is substantially parallel to the extension direction (XY plane direction in the figure) of the main surface of the wiring board 50. However, the insertion/removal direction in which the flexible printed wiring board 60 is inserted into and removed from the connector 1 is not particularly limited to this. For example, the insertion/removal direction in which the flexible printed wiring board 60 is inserted into and removed from the connector 1 may be substantially perpendicular to the extension direction (XY plane direction in the figure) of the main surface of the wiring board 50.

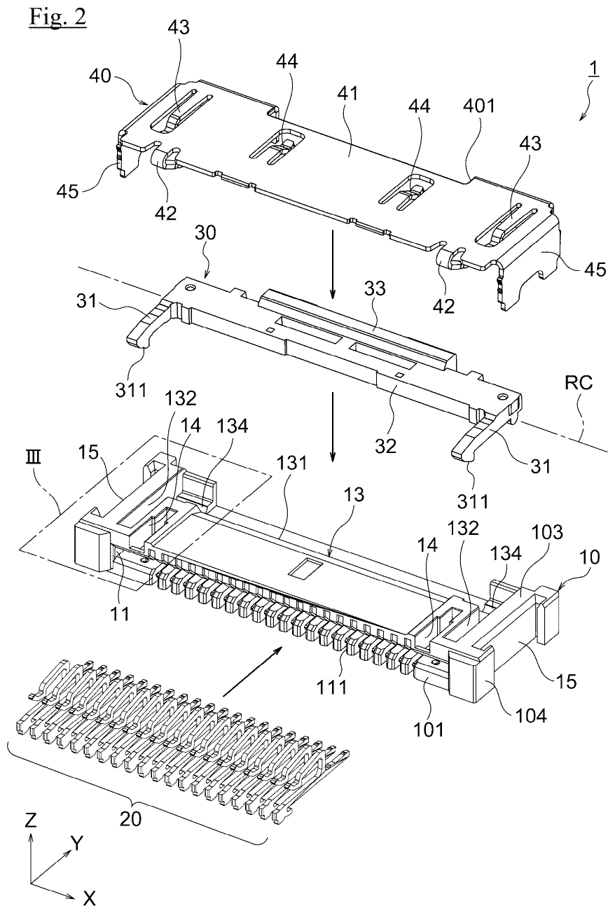

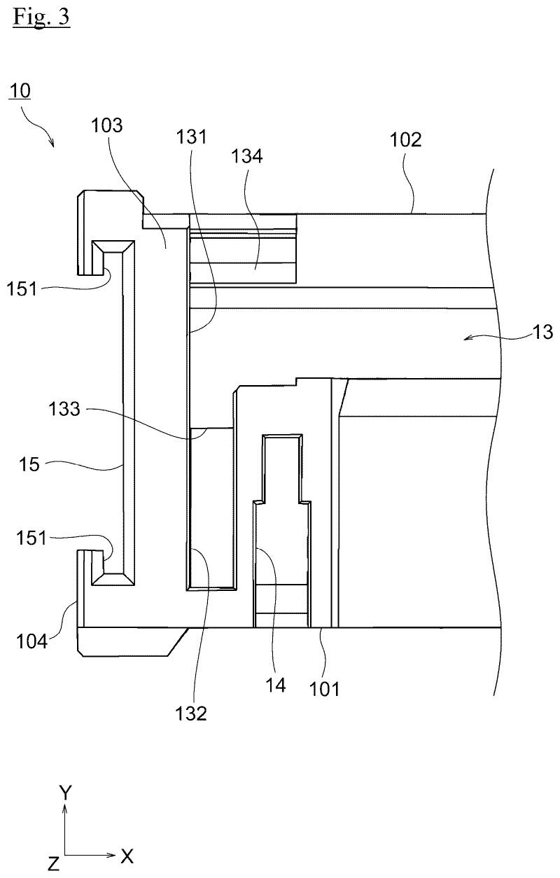

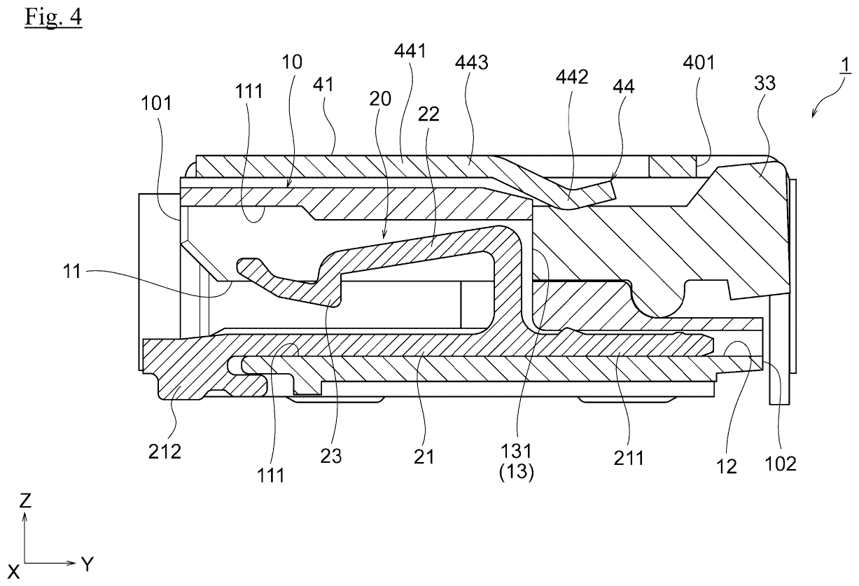

FIG. 2 is an exploded perspective view showing the connector 1 in the embodiment of the present invention. FIG. 3 is a view of the housing 10 in one or more embodiments of the present invention and is an enlarged plan view of part III in FIG. 2. FIG. 4 is an end view taken along line IV-IV in FIG. 1.

As shown in FIG. 2, the connector 1 of one or more embodiments includes a housing 10, a plurality of (20 in one or more embodiments) terminals 20, a lock member 30, and a shell 40. The connector 1 is assembled by covering the housing 10 with the shell 40 to sandwich the lock member 30 in a state in which the lock member 30 is placed on the housing 10 accommodating the terminal 20. The number of terminals 20 included in the connector 1 is not particularly limited to the above, and it can be set according to, for example, the number of signal patterns 61 included in the flexible printed wiring board 60.

The housing 10 is made of an electrically insulating material. Although not particularly limited, for example, the housing 10 is a molded product made of a resin material. As shown in FIG. 2 and FIG. 3, the housing 10 includes an insertion part 11, a recess 13, a pair of holes 14, and a pair of holding parts 15.

As shown in FIG. 2 and FIG. 4, the insertion part 11 is a recess that opens to the front surface 101 of the housing 10. The insertion part 11 extends along the width direction (X direction in the figure) of the connector 1.

A plurality of (20 in one or more embodiments) grooves 111 are formed in the insertion part 11. Each of the grooves 111 extends along the front-to-rear direction (Y direction in the figure) of the connector 1. The plurality of grooves 111 are arranged at equal intervals along the width direction (X direction in the figure) of the connector 1 and are arranged in parallel to each other. Furthermore, as shown in FIG. 4, a through hole 12 is formed on an extension line of the groove 111. The through hole 12 penetrates the housing 10 and opens to the back surface 102 of the housing 10. The terminals 20 are inserted into the respective grooves 111 and the respective through holes 12.

As shown in FIG. 2 and FIG. 3, the recess 13 is a substantially U-shaped recess formed in the upper surface 103 of the housing 10. The recess 13 has a shape corresponding to the lock member 30. The lock member 30 is inserted into the recess 13, and the lock member 30 is held by the housing 10. The recess 13 includes a main part 131 and a pair of extension parts 132.

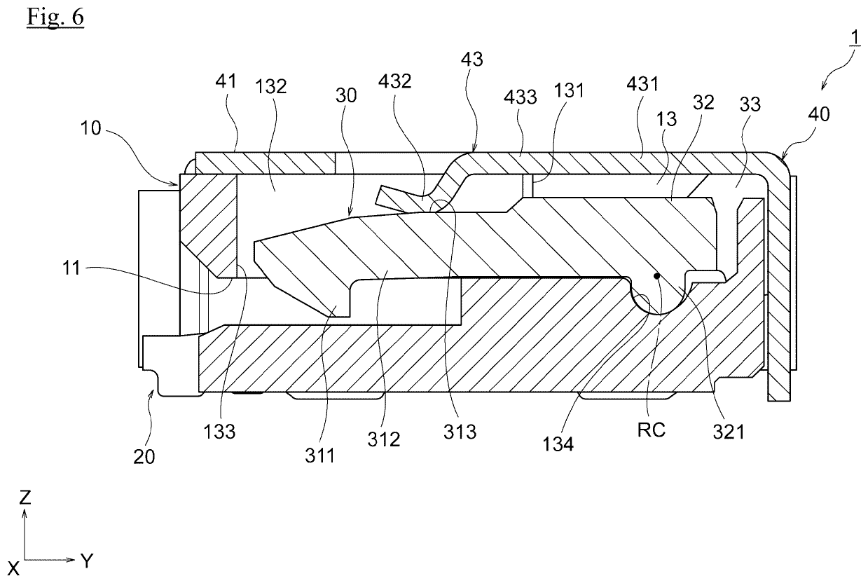

The main part 131 extends in the width direction (X direction in the figure) of the connector 1. The connection part 32 and the operation part 33 (described later) of the lock member 30 are inserted into the main part 131. A support surface 134 is formed on the bottom of the main part 131. The support surface 134 has a semicircular cross-sectional shape corresponding to the semicircular column part 321 (described later) of the lock member 30 (refer to FIG. 6 described later). The lock member 30 is rotatably held by the housing 10 around the center RC of the semicircular column part 321 as the rotation center. The main part 131 opens to the rear surface 102 of the housing 10 to allow the operation part 33 (described later) of the lock member 30 to protrude rearward.

The pair of extension parts 132 extend from both ends of the main part 131 toward the front (−Y direction in the figure) of the connector 1. Lock arms 31 (described later) of the lock member 30 are respectively inserted into the extension parts 132. Further, through holes 133 are respectively formed in the bottom parts of the extension parts 132 (refer to FIG. 3 and FIG. 6 described below). Each of the through holes 133 penetrates the housing 10 and opens to the insertion part 11. A hook 311 (described later) of the lock member 30 is positioned within the insertion part 11 of the housing 10 through the through hole 133.

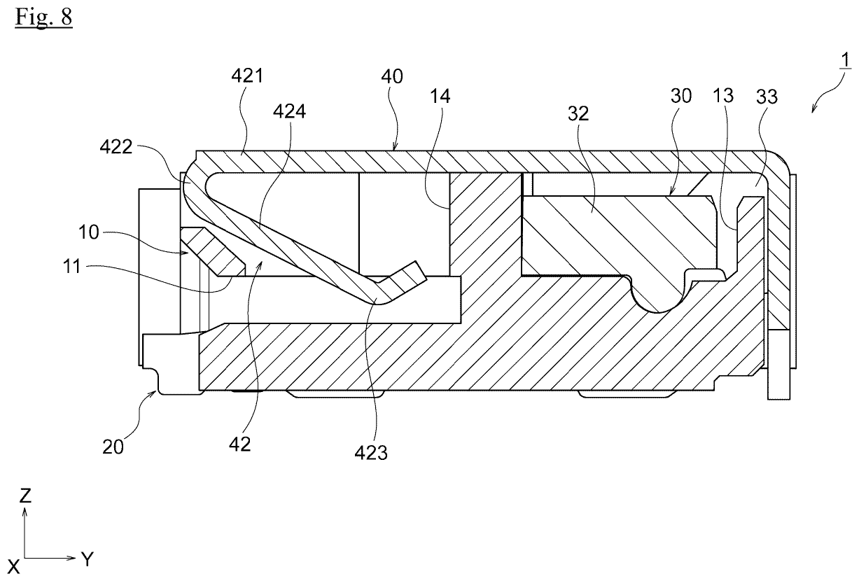

As shown in FIG. 2 and FIG. 3, the pair of holes 14 are disposed in the vicinity of both ends of the insertion part 11. Specifically, each of the holes 14 is disposed so as to be located between the outermost groove 111 of the insertion part 11 and the through hole 133 of the recess 13 in the width direction (X direction in the figure) of the connector 1. Each of the holes 14 opens to the upper surface 103 of the housing 10 and penetrates the housing 10 to open to the insertion part 11 of the housing 10 (refer to FIG. 8 described later). The protruding pieces 42 (described later) of the shell 40 are inserted into the pair of holes 14. The number and positions of the holes 14 are not particularly limited to those described above and it can be set in accordance with the number and positions of the ground patterns 62 of the flexible printed wiring board 60.

As shown in FIG. 2 and FIG. 3, the pair of holding parts 15 are formed on both side surfaces 104 of the housing 10. Each of the holding parts 15 includes a recess having two grooves 151 facing each other. Each of the grooves 151 penetrates the housing 10 along the up-down direction (Z direction in the figure) of the connector 1. The shell 40 is held by (fixed to) the housing 10 by press-fitting a side plate part 45 of the shell 40 into the groove 151.

Each of the terminals 20 is made of a conductive material. Although not particularly limited, the terminal 20 is made of, for example, a metal material. As shown in FIG. 4, the terminal 20 includes a fixed part 21, an elastic part 22, and a contact part 23. The terminal 20 is formed by processing a metal plate material, and the fixed part 21, the elastic part 22, and the contact part 23 are integrally formed. The terminals 20 are respectively inserted into the grooves 111 of the insertion part 11 of the housing 10 described above.

The fixed part 21 includes a lock part 211 in the rear side (+Y direction side in the figure) portion. The terminal 20 is held by (fixed to) the housing 10 by press-fitting the lock part 211 into the through hole 12 of the housing 10 described above. Further, the fixed part 21 includes a board connection part 212 in the front side (−Y direction side in the figure) portion. The terminal 20 is electrically connected to the wiring board 50 by joining the board connection part 212 to the signal pattern (wiring pattern) of the wiring board 50 by soldering or the like.

The elastic part 22 branches upward (+Z direction in the figure) from the center of the fixed part 21 and extends in a substantially L-shape. The contact part 23 is connected to the other end of the elastic part 22 so that the contact part 23 protrudes from the groove 111 into the space of the insertion part 11. That is, the elastic part 22 is interposed between the contact part 23 and the fixed part 21, and the contact part 23 can move by elastic deformation of the elastic part 22. Therefore, when the flexible printed wiring board 60 is inserted into the connector 1, the contact part 23 of the terminal 20 contacts the signal pattern 61 of the flexible printed wiring board 60, and the flexible printed wiring board 60 and the terminal 20 are electrically connected to each other.

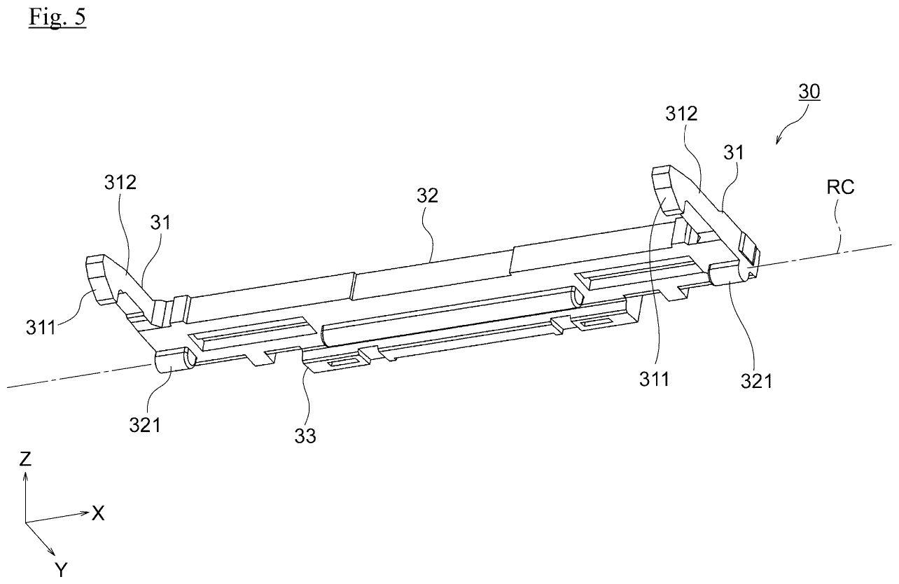

FIG. 5 is a perspective view of the lock member 30 as viewed from below in one or more embodiments, and FIG. 6 is a cross-sectional view taken along line VI-VI in FIG. 1.

The lock member 30 is made of an electrically insulating material. As shown in FIG. 2 and FIG. 5, the lock member 30 includes a pair of lock arms 31, a connection part 32, and an operation part 33 (i.e., push bar). The lock member 30 has a substantially U-shape that corresponds to the shape of the recess 13 of the housing 10 described above. Although not particularly limited, for example, the lock member 30 is a molded product made of a resin material, and the lock arms 31, the connection part 32, and the operation part 33 are integrally formed.

The pair of lock arms 31 extend along the front-rear direction (Y direction in the figure) of the connector 1. Each of the lock arms 31 includes a hook 311 at the front-end thereof. The hook 311 protrudes downward (−Z direction in the figure) from the main body part 312 of the lock arm 31. The pair of lock arms 31 are respectively inserted into the extension parts 132 of the recess 13 of the housing 10 described above. Further, as shown in FIG. 6, the hooks 311 are respectively inserted into the through holes 133 of the extension parts 132 described above. When the flexible printed wiring board 60 is inserted into the connector 1, the hook 311 enters the cutout 63 of the flexible printed wiring board 60 and engages with the convex part 64 of the flexible printed wiring board 60.

As shown in FIG. 2 and FIG. 5, the rear ends of the pair of lock arms 31 are connected to the connection part 32. That is, the connection part 32 is interposed between the pair of lock arms 31, and the lock arms 31 are connected to both ends of the connection part 32, and the connection part 32 connects the lock arms 31 to each other. The operation part 33 for an operator to operate the connector 1 is disposed in the connection part 32. The operation part 33 protrudes from the center of the connection part 32 toward the rear (+Y direction in the figure) and upward (+Z direction in the figure) of the connection part 32. The connection part 32 and the operation part 33 are inserted into the main part 131 of the recess 13 of the housing 10 described above.

Further, as shown in FIG. 5 and FIG. 6, the connection part 32 includes a semicircular column part 321 on the bottom surface thereof. The semicircular column part 321 has a semicircular cross-sectional shape that corresponds to the shape of the support surface 134 of the housing 10 described above. Therefore, the lock member 30 is rotatably held by the housing 10 around the center RC of the semicircular column part 321 as the rotation center.

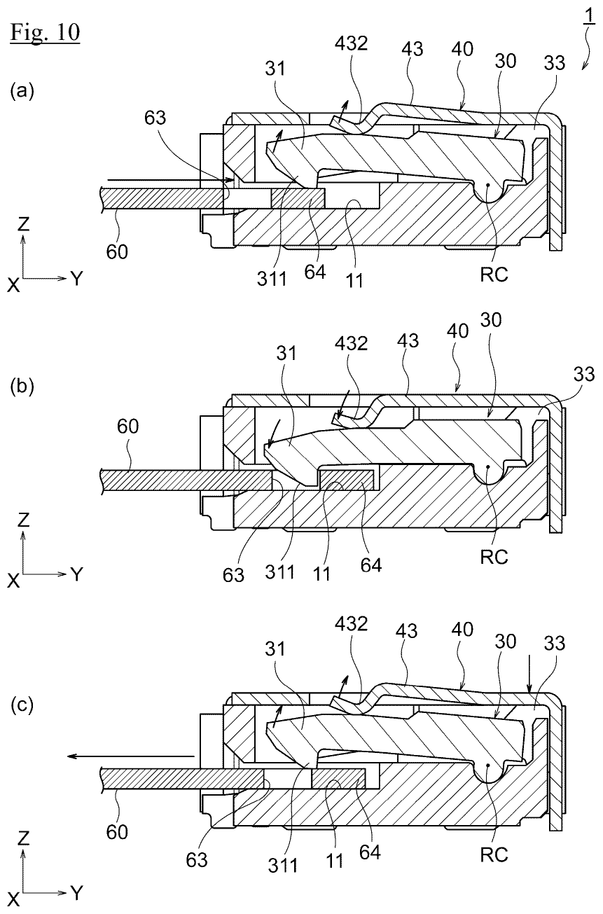

In one or more embodiments, the lock member 30 can rotate between a lock position and an unlock position. The lock position is a position in which the connector 1 locks the flexible printed wiring board 60 and the flexible printed wiring board 60 cannot be pulled out from the connector 1 (refer to FIG. 6 and FIG. 10(b) described later). When the lock member 30 is in the lock position, the hook 311 enters the cutout 63 of the flexible printed wiring board 60 and engages with the convex part 64. On the other hand, the unlock position is a position in which the lock of the connector 1 is released and the flexible printed wiring board 60 can be pulled out from the insertion part 11 of the housing 10 (refer to FIG. 10(c) described later). When the lock member 30 is in the unlock position, the hook 311 is separated from the cutout 63 of the flexible printed wiring board 60 and the engagement between the hook 311 and the convex part 64 is released.

When the lock arm 31 of the lock member 30 abuts against the bottom surface of the extension part 132 of the recess 13 of the housing 10, the rotation of the lock member 30 is restricted at the lock position. On the other hand, when the operation part 33 of the lock member 30 abuts against the bottom surface of the main part 131 of the recess 13 of the housing 10, the rotation of the lock member 30 is restricted at the unlock position.

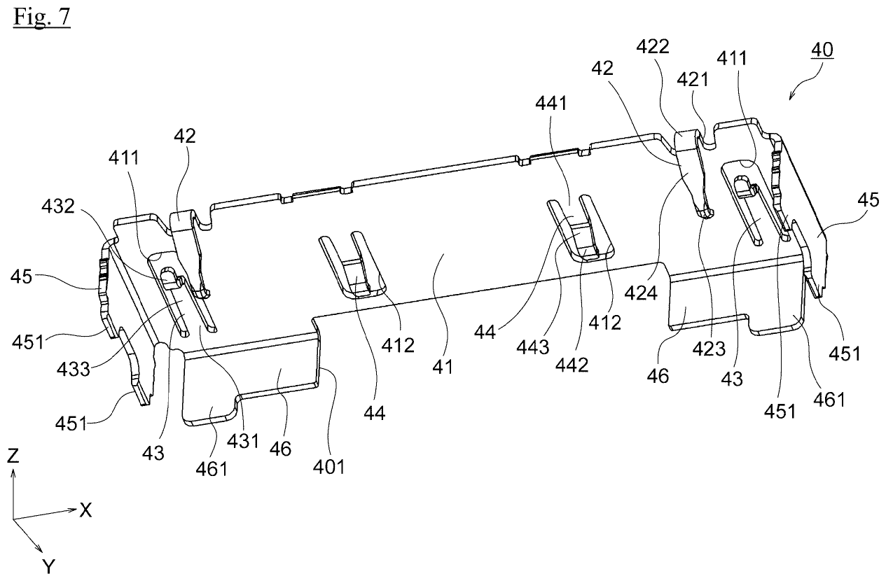

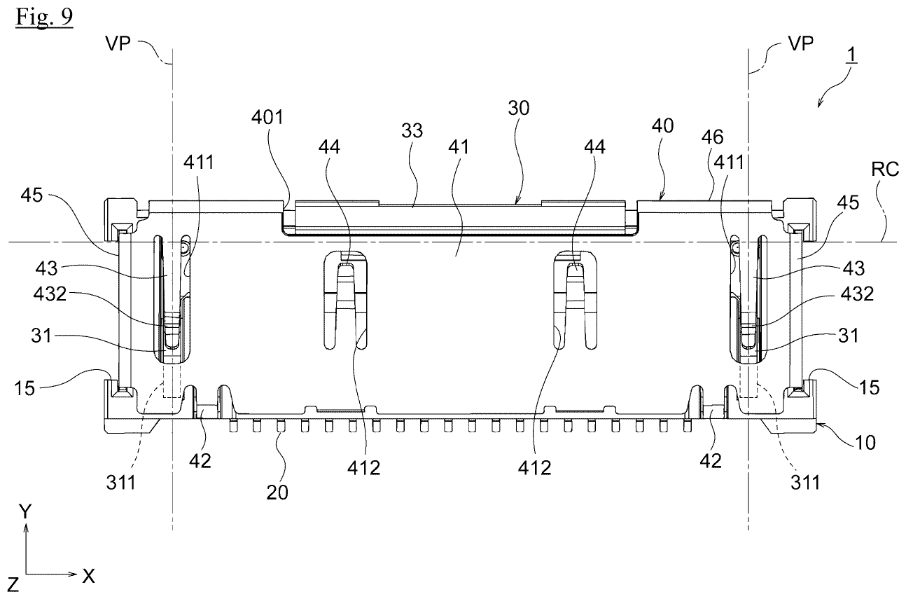

FIG. 7 is a perspective view of the shell 40 as viewed from below in one or more embodiments of the present invention, FIG. 8 is a cross-sectional view taken along line VIII-VIII in FIG. 1, and FIG. 9 is a plan view of the connector 1 in one or more embodiments of the present invention.

The shell 40 is made of a conductive material. Although not particularly limited, the shell 40 is made of, for example, a metal material. As shown in FIG. 2 and FIG. 7, the shell 40 includes an upper plate part 41, a pair of side plate parts 45, and a back plate part 46. The upper plate part 41 of the shell 40 corresponds to an example of the “plate-shaped part” (i.e., plate) in the aspect of the present invention. The shell 40 is formed by processing a metal plate material, and the upper plate part 41, the side plate parts 45, and the back plate part 46 are integrally formed.

The shell 40 functions as an electromagnetic shield, since the shell 40 is electrically conductive and covers the housing 10 that holds the terminals 20. Also, the shell 40 has the function of holding the lock member 30, since, as described above, the shell 40 covers the upper surface 103 of the housing 10 in a state in which the lock member 30 is placed in the recess 13 of the housing 10, and the lock member 30 is sandwiched between the housing 10 and the shell 40.

The upper plate part 41 is a plate-like portion that extends substantially parallel to the width direction (X direction in the figure) of the connector 1 and the front-rear direction (Y direction in the figure) of the connector 1. When the shell 40 is attached to the housing 10, the upper plate part 41 covers the upper surface 103 of the housing 10.

The pair of side plate parts 45 extend downward (−Z direction in the figure) from both edges of the upper plate part 41 in the width direction (X direction in the figure) of the connector 1. The back plate part 46 also extends downward (−Z direction in the figure) from a rear (+Y direction in the figure) edge of the connector 1. When the shell 40 is attached to the housing 10, the side plate parts 45 and back plate part 46 respectively cover the side surface 104 and rear surface 102 of the housing 10.

The side plate parts 45 and the back plate part 46 respectively have protrusions 451 and 461 at their distal ends. The shell 40 is electrically connected to the wiring board 50 by joining the protrusions 451 and 461 to the ground patterns (wiring patterns) of the wiring board 50 by soldering or the like. Further, a cutout 401 for exposing the above-mentioned operation part 33 of the lock member 30 from the shell 40 is continuously formed in the upper plate part 41 and the back plate part 46. Although not particularly shown, instead of the cutout 401, an opening for exposing the operation part 33 from the shell 40 may be continuously formed in the upper plate part 41 and the back plate part 46.

Furthermore, the shell 40 of one or more embodiments includes three types of protruding pieces 42 to 44 that protrude downward from the upper plate part 41. All of the protruding pieces 42 to 44 are formed integrally with the upper plate part 41. That is, each of the protruding pieces 42 to 44 constitutes a part of the shell 40.

The protruding piece 42 corresponds to an example of the “second protruding piece” in the aspect of the present invention, the protruding piece 43 corresponds to an example of the “first protruding piece” in the aspect of the present invention, and the protruding piece 44 corresponds to an example of the “third protruding piece” in the aspect of the present invention. Either one of the protruding pieces 42 and 44 may be omitted, or both of the protruding pieces 42 and 44 may be omitted.

The protruding piece 42 is a contact piece that contacts the ground pattern 62 of the flexible printed wiring board 60 when the flexible printed wiring board 60 is inserted into the connector 1.

The protruding piece 42 is disposed in the upper plate part 41 of the shell 40 at a position corresponding to the hole 14 of the housing 10 described above. As shown in FIG. 7 and FIG. 8, the protruding piece 42 includes a fixed end 421, a bent part 422, a contact part 423, and an extension part 424.

The protruding piece 42 is connected to the front (−Y direction in the figure) edge of the upper plate part 41 at the fixed end 421. The protruding piece 42 is bent at the bent part 422 and extends toward the rear (+Y direction in the figure) and downward (−Z direction in the figure) of the connector 1, and therefore the protruding piece 42 can elastically deform. The protruding piece 42 has the contact part 423 at the distal end. The extension part 424 extends between the contact part 423 and the bent part 422, and the bent part 422 and the contact part 423 are connected via the extension part 424. That is, the protruding piece 42 is a spring piece of a cantilever support structure that has the contact part 423 as a free end and is elastically deformable.

When the shell 40 is attached to the housing 10, the protruding piece 42 is inserted into the hole 14 of the housing 10. When the flexible printed wiring board 60 is inserted into the connector 1, the protruding piece 42 elastically deforms and the contact part 423 of the protruding piece 42 contacts the ground pattern 62 described above.

On the other hand, each of the protruding pieces 43 and 44 is a contact piece that is in contact with the lock member 30 and biases the lock member 30 toward the lock position described above. The protruding pieces 43 and 44 are located on the opposite side of the flexible printed wiring board 60 with respect to the lock member 30. That is, the protruding pieces 43 and 44 are disposed above (the +Z direction in the figure) the lock member 30.

The protruding piece 43 is disposed in the upper plate part 41 of the shell 40 at a position corresponding to the lock arm 31 of the lock member 30. As shown in FIG. 7 and the above-mentioned FIG. 6, the protruding piece 43 has a fixed end 431, a contact part 432, and an extension part 433.

The protruding piece 43 is connected to the edge of the opening 411 of the upper plate part 41 at the fixed end 431. The protruding piece 43 extends from the fixed end 431 toward the front (−Y direction in the figure) of the connector 1. Further, the protruding piece 43 has the contact part 432 protruding downward (−Z direction in the figure) at the distal end. The contact part 432 is in contact with the upper surface (the surface on the +Z direction side in the figure) of the main body part 312 of the lock arm 31. The extension part 433 extends between the fixed end 431 and the contact part 432, and the fixed end 431 and the contact part 432 are connected via the extension part 433. That is, the protruding piece 43 is a spring piece of a cantilever support structure that has the contact part 432 as a free end and that can elastically deform. The protruding piece 43 presses the lock member 30 downward (−Z direction in the figure) to bias the lock member 30 toward the lock position described above.

In one or more embodiments, as shown in FIG. 9, the hook 311 of the lock member 30 and the contact part 432 of the protruding piece 43 of the shell 40 are located on the same virtual plane VP. The virtual plane VP is a plane that extends in a direction substantially perpendicular to the rotation center RC of the rotary motion of the lock member 30 with respect to the housing 10. In one or more embodiments, since the hook 311 and the contact part 432 are located on the same virtual plane VP, the portion 313 (refer to FIG. 6) of the lock member 30 with which the contact part 432 is in contact can be disposed close to the hook 311.

The protruding piece 44 is disposed in the upper plate part 41 of the shell 40 at a position corresponding to the connection part 32 of the lock member 30. That is, the protruding piece 44 is disposed closer to the center of the upper plate part 41 in the width direction (X direction in the drawing) of the shell 40 than the protruding piece 43. As shown in FIG. 7 and the above-mentioned FIG. 4, the protruding piece 44 includes a fixed end 441, a contact part 442, and an extension part 443.

The protruding piece 44 is connected to the edge of the opening 412 of the upper plate part 41 at the fixed end 441. The protruding piece 44 extends from the fixed end 441 toward the rear (+Y direction in the figure) of the connector 1. Further, the protruding piece 44 has the contact part 442 protruding downward (−Z direction in the figure) at the distal end. The contact part 442 is in contact with the upper surface (the surface on the +Z direction side in the figure) of the connection part 32 of the lock arm 31. The portion of the connection part 32 with which the contact part 442 is in contact is a portion in front (−Y direction in the figure) of the rotation center RC in the front-rear direction (Y direction in the figure) of the connector 1. The extension part 443 extends between the fixed end 441 and the contact part 442, and the fixed end 441 and the contact part 442 are connected via the extension part 443. That is, the protruding piece 44 is a spring piece of a cantilever support structure that has the contact part 442 as a free end and that can elastically deform. The protruding piece 44 presses the lock member 30 downward (−Z direction in the figure) to bias the lock member 30 toward the locking position described above.

Hereinafter, the operation of inserting and removing the flexible printed wiring board 60 into and from the connector 1 in one or more embodiments will be described with reference to FIG. 10(a) to FIG. 10(c).

FIG. 10(a) to FIG. 10(c) are cross-sectional views showing the operation of the connector 1 in one or more embodiments. Specifically, FIG. 10(a) shows a state in the middle of inserting the flexible printed wiring board 60 into the connector 1, FIG. 10(b) shows a state in which the lock member 30 locks the flexible printed wiring board 60, and FIG. 10(c) shows a state in which the lock of the lock member 30 is released and the flexible printed wiring board 60 is removed from the connector 1. FIG. 10(a) to FIG. 10(c) are cross-sectional views corresponding to the above-mentioned FIG. 6.

When the flexible printed wiring board 60 is inserted into the connector 1, as shown in FIG. 10(a), first, the operator inserts the flexible printed wiring board 60 into the insertion part 11 of the housing 10 of the connector 1 and makes the front-end of the flexible printed wiring board 60 abut against the hook 311 of the lock member 30. When the flexible printed wiring board 60 is further pushed into the insertion part 11 from this state, the lock member 30 rotates clockwise in the figure against the biasing force of the protruding pieces 43 and 44 of the shell 40, and the hook 311 of the lock member 30 is pushed up and rides onto the convex part 64 of the flexible printed wiring board 60.

Then, when the flexible printed wiring board 60 is further pushed into the insertion part 11 from the state shown in FIG. 10(a), as shown in FIG. 10(b), the hook 311 of the lock member 30 climbs over the convex part 64 of the flexible printed wiring board 60, the lock member 30 rotates counterclockwise in the figure by the biasing force of the protruding pieces 43 and 44 of the shell 40, and the hook 311 enters the cutout 63 of the flexible printed wiring board 60. That is, the lock member 30 is constantly biased toward the “lock position” by the biasing force of the protruding pieces 43 and 44. As a result, the hook 311 and the convex part 64 engage with each other, and the flexible printed wiring board 60 is locked by the lock member 30.

On the other hand, when the flexible printed circuit board 60 is removed from the connector 1, as shown in FIG. 10(c), the operator presses the operation part 33 of the lock member 30 downward (−Z direction in the figure). By this pressing, the lock member 30 rotates clockwise in the figure against the biasing force of the protruding pieces 43 and 44 of the shell 40, the hook 311 of the lock member 30 moves above the cutout 63 of the flexible printed wiring board 60, and the lock of the flexible printed wiring board 60 by the lock member 30 is released. That is, the lock member 30 moves to the “unlock position” by pressing the operation part 33.

In this state, the operator pulls the flexible printed wiring board 60 toward the outside of the housing 10, and therefore the flexible printed wiring board 60 can be removed from the connector 1.

As described above, in one or more embodiments, the hook 311 of the lock member 30 and the contact part 432 of the protruding piece 43 are located on the same virtual plane VP extending in a direction substantially perpendicular to the rotation axis RC of the lock member 30. Therefore, since the portion 313 of the lock member 30 with which the contact part 432 is in contact can be disposed close to the hook 311, it is possible to improve the holding force of the connector 1 for holding the flexible printed wiring board 60.

Further, in one or more embodiments, since the protruding piece 43 is integrally formed with the shell 40, it is also possible to reduce the number of components of the connector 1. In particular, since the shell 40 functions as an electromagnetic shield, it is possible to further reduce the number of components of the connector 1.

Further, in one or more embodiments, since shell 40 is held by the housing 10 so that the lock member 30 is interposed between the housing 10 and the shell 40, the lock member 30 is sufficiently prevented from leaving the housing 10.

Further, in one or more embodiments, since the connector 1 includes the protruding piece 44 in addition to the protruding piece 43 as a member for biasing the lock member 30, it is possible to reinforce and stabilize the biasing force of the lock member 30.

It should be noted that the embodiments described above are described to facilitate understanding of the present disclosure and are not described to limit the present disclosure. It is therefore intended that the elements disclosed in the above embodiments include all design modifications and equivalents to fall within the technical scope of the present disclosure.

For example, although the protruding piece 43 is formed integrally with the shell 40 in the above-described embodiments, the protruding piece 43 may be a separate member independent of the shell 40 and the protruding piece 43 may be joined to the shell 40 as long as the protruding piece 43 is located on the opposite side of the flexible printed wiring board 60 with respect to the lock member 30.

Similarly, although the protruding piece 44 is formed integrally with the shell 40 in the above-described embodiments, the protruding piece 44 may be a separate member independent of the shell 40 and the protruding piece 44 may be joined to the shell 40 as long as the protruding piece 44 is located on the opposite side of the flexible printed wiring board 60 with respect to the lock member 30.

Although the housing 10 is covered with a shell 40 made of a conductive material in order to impart the electromagnetic shield function to the connector 1 in the above-described embodiments, instead of the shell 40, the housing 10 may be covered with a cover member made of a non-conductive material, such as a resin material.

In this case, the protruding piece 43 may be formed integrally with the cover member, or the protruding piece 43 may be a separate member independent of the cover member and may be joined to the cover member. Similarly, the protruding piece 44 may be formed integrally with the cover member, or the protruding piece 44 may be a separate member independent of the cover member and may be joined to the cover member.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 . . . Connector
10 . . . Housing
101 . . . Front surface
102 . . . Back surface
103 . . . Upper surface
104 . . . Side surface
11 . . . Insertion part
111 . . . Groove
12 . . . Through hole
13 . . . Recess
131 . . . Main part
132 . . . Extension part
133 . . . Through hole
134 . . . Support surface
14 . . . Hole
15 . . . Holding part
151 . . . Groove
20 . . . Terminal
21 . . . Fixed part
211 . . . Lock part
212 . . . Board connection part
22 . . . Elastic part
23 . . . Contact part
30 . . . Lock member
31 . . . Lock arm
311 . . . Hook
312 . . . Main body part
313 . . . Portion with which Protruding piece is in contact
32 . . . Connection part
321 . . . Semicircular column part
RC . . . Rotation center
33 . . . Operation part
40 . . . Shell
401 . . . Cutout
41 . . . Upper plate part
411 and 412 . . . Opening
42 . . . Protruding piece
421 . . . Fixed end
422 . . . Bent part
423 . . . Contact part
424 . . . Extension part
43 . . . Protruding piece
431 . . . Fixed end
432 . . . Contact part
433 . . . Extension part
44 . . . Protruding piece
441 . . . Fixed end
442 . . . Contact part
443 . . . Extension part
45 . . . Side plate part
451 . . . Protrusion
46 . . . Back plate part
461 . . . Protrusion
50 . . . Wiring board
60 . . . Flexible printed wiring board
61 . . . Signal pattern
62 . . . Ground pattern
63 . . . Cutout
64 . . . Convex part
VP . . . Virtual plane

1. An electrical connector comprising:
a terminal to which a signal transmission member is electrically connected;
a housing that holds the terminal and that comprises an insertion part into which the signal transmission member is inserted;
a lock that is rotatably supported by the housing and that comprises a hook that engages with the signal transmission member;
a cover that comprises plate that covers the housing; and
first protruding piece that biases the lock toward a lock position in which the hook engages with the signal transmission member and that comprises a contact part in contact with the lock, wherein
the cover is held by the housing such that the lock is interposed between the housing and the cover,
the first protruding piece is disposed on an opposite side of the signal transmission member with respect to the lock and that protrudes from the plate toward the lock,
the lock is rotatable between the lock position and an unlock position in which the signal transmission member can be removed from the insertion part, and
the hook and the contact part are disposed on a same virtual plane extending in a direction substantially perpendicular to a rotation axis of the lock.

2. The electrical connector according to claim 1, wherein the first protruding piece is integrally formed with the plate.

3. The electrical connector according to claim 1, wherein
the is made of a conductive material, and
the cover further comprises a second protruding piece that is integrally formed with the plate and that is electrically connected to the signal transmission member.

4. The electrical connector according to claim 1, wherein
the lock further comprises a pair of lock arms each of which comprises the hook at a front-end of the each of the pair of lock arms, and
the contact part is in contact with the each of the pair of lock arms.

5. The electrical connector according to claim 1, wherein
the lock further comprises:
a pair of lock arms each of which comprises the hook at a front-end of the each of the pair of lock arms;
a connection part that connects the pair of lock arms; and
a push bar disposed on the connection part, and
the cover has a cutout or an opening through which the push bar is exposed.

6. The electrical connector according to claim 5, wherein the cover further comprises a second protruding piece that is integrally formed with the like plate and that is in contact with the connection part and biases the lock toward the lock position.

7. The electrical connector according to claim 1, wherein
the first protruding piece comprises:
the contact part is as a free end of the first protruding piece;
a fixed end; and
an extension part that extends between the contact part and the fixed end, and
the contact part, the extension part, and the fixed end are disposed on an opposite side of the signal transmission member with respect to the lock.
